(19) United States
(12) Patent Application Publication
(10) Pub. No.: US 2021/0383229 A1
(43) Pub. Date: Dec. 9, 2021

(54) MACHINE LEARNING SYSTEMS FOR LOCATION CLASSIFICATION AND METHODS FOR USING SAME

(71) Applicant: Job Market Maker, LLC, Charleston, SC (US)

(72) Inventors: Joseph W. Hanna, Charleston, SC (US); David Trachtenberg, Charleston, SC (US); Christina R. Petrosso, Folly Beach, SC (US)

(21) Appl. No.: 17/341,099

(22) Filed: Jun. 7, 2021

Related U.S. Application Data
(60) Provisional application No. 63/035,365, filed on Jun. 5, 2020.

(51) Int. Cl. G06N 3/08; G06N 3/04; G06F 40/279

(52) U.S. Cl. CPC G06N 3/08; G06F 40/279; G06N 3/04

(57) ABSTRACT

A machine learning system can include a data store and at least one computing device in communication with the data store. The data store can include entity data. The computing device can receive data describing at least one aspect of a position for the entity and generate metadata for the position based on the data describing the at least one aspect, the metadata including skills and tasks associated with the position. The computing device can identify task locations for the entity, determine a distribution of capacity across the task locations based on the entity data, and generate metric scores including a collaboration score, a remote work score, and an estimated remuneration range across each task location. The computing device can generate location scores for each task location based on a weighing of each metric score.

### CROSS REFERENCE TO RELATED APPLICATIONS

This application claims the benefit of and priority to U.S. Application No. 63,035,365, filed Jun. 5, 2020, titled “LOCATION RECOMMENDATION ENGINE,” the disclosure of which is incorporated herein by reference in its entirety.

### TECHNICAL FIELD

The present systems and processes relate generally to machine learning-based classification of locations.

### BACKGROUND

Machine learning generally refers to an application of artificial intelligence (AI) that provides systems the ability to automatically learn and improve from experience without being explicitly programmed. Machine learning typically focuses on the development of computer programs that can access data and use it to learn for themselves.

Previous approaches to identifying suitable labor sources and ideal labor placements have typically relied upon heuristics. However, heuristics-based approaches may fail to consider or accurately weight all factors that may influence a location's suitability for labor recruitment or placement. Accordingly, there exists an unmet need for systems and methods that can more accurately predict suitable locations for recruiting and assigning labor.

### BRIEF SUMMARY OF THE DISCLOSURE

Briefly described, and according to one embodiment, aspects of the present disclosure generally relate to systems and methods for identifying and evaluating office locations for optimizing workplace hiring, including remote working options in lieu of opening new office locations.

In one or more embodiments, the disclosed system may determine an optimal office location or locations for a job position. For example, the system may determine that an office in Charleston, S.C. is the optimal location to hire a software programmer for a company that has office locations in Atlanta, Ga., Tampa, Fla., Seattle, Wash., and Charleston, S.C.). In various embodiments, the disclosed system may utilize machine learning systems and processes for location recommendations for businesses hiring employees. In several embodiments, the businesses may be hiring for jobs that are paid hourly, annually, by a contracted price, or set by a local or state union.

In several embodiments, the disclosed system may determine several additional factors that may be factored into and weighed during the determination of location suitability. In various embodiments, the disclosed system may utilize one or more machine learning algorithms to determine the metric scores for each additional factor for each location, and further determine a location score for each location based at least in part on the metric scores. In one or more embodiments, the present system may be implemented to evaluate current job positions within a company, institution, etc. In some embodiments, the system may also identify one or more machine learning parameters (e.g., portions of data, information, etc.) that are most influential in determining a specific location recommendation for a certain job position.

In various embodiments, the disclosed system may output a numerical score and/or suitability classification for each candidate location from which a position may be filled. In at least one embodiment, the system generates rankings of candidate locations (e.g., from most to least suitable, most to least expensive, etc.). Additionally, in a further embodiment, the disclosed system may generate a searchable report for the user to see the rankings of each location considered, the total cost of locating the job position at the location, the total cost of one location compared to making the job position remote, and/or other such information.

According to a first aspect, a machine learning system, comprising: A) a data store comprising entity data for an entity, the entity data comprising data describing a plurality of individuals associated with the entity; B) at least one computing device in communication with the data store, the at least one computing device being configured to: 1) receive data describing at least one aspect of a position for the entity; 2) generate metadata for the position based on the data describing the at least one aspect of the position, the metadata comprising a plurality of skills and tasks associated with the position; 3) identify a plurality of task locations for the entity; 4) determine a distribution of capacity across the plurality of task locations based on the entity data; 5) generate a plurality of metric scores comprising a collaboration score, a remote work score, and an estimated remuneration range across each of the plurality of task locations; and 6) generate a plurality of location scores for each of the plurality of task locations based on a weighing of each of the plurality of metric scores.

According to a further aspect, the machine learning system of the first aspect or any other aspect, wherein the at least one computing device is further configured to generate a user interface including a subset of the plurality of task locations according to a ranking of the plurality of location scores.

According to a further aspect, the machine learning system of the first aspect or any other aspect, wherein the at least one computing device is further configured to generate the plurality of location scores using deep learning and natural language processing on the plurality of metric scores.

According to a further aspect, the machine learning system of the first aspect or any other aspect, wherein the plurality of metric scores comprises a projected remuneration trend across each of the plurality of task locations.

According to a further aspect, the machine learning system of the first aspect or any other aspect, wherein the plurality of metric scores comprises a supply to demand ratio at each of the plurality of task locations.

According to a further aspect, the machine learning system of the first aspect or any other aspect, wherein the at least one computing device is further configured generate the plurality of location scores by applying a machine learning model.

According to a further aspect, the machine learning system of the first aspect or any other aspect, wherein the at least one computing device is further configured train the machine learning model using a training data set comprising a plurality of inputs and a plurality of known outcomes corresponding to the inputs.

According to a second aspect, a machine learning method, comprising: A) receiving, via at least one computing device, data describing at least one aspect of a position for an entity; B) generating, via the at least one computing device, metadata for the position based on the data describing the at least one aspect of the position, the metadata comprising a plurality of skills and tasks associated with the position; C) identifying, via the at least one computing device, a plurality of task locations for the entity; D) determining, via the at least one computing device, a distribution of capacity across the plurality of task locations based on entity data for the entity, wherein the entity data comprising data describing a plurality of individuals associated with the entity; E) generating, via the at least one computing device, a plurality of metric scores comprising a collaboration score, a remote work score, an estimated remuneration range across each of the plurality of task locations; and F) generating, via the at least one computing device, a plurality of location scores for each of the plurality of task locations based on a weighing of each of the plurality of metric scores.

According to a further aspect, the machine learning method of the second aspect or any other aspect, further comprising: A) periodically retrieving task data from a plurality of third party data sources; and B) processing the retrieved task data to generate processed task data, wherein the metadata is further based on the processed task data.

According to a further aspect, the machine learning method of the second aspect or any other aspect, further comprising: A) determining at least one most influential parameter associated with the plurality of location scores; and B) rendering a user interface comprising the at least one most influential parameter on a display.

According to a further aspect, the machine learning method of the second aspect or any other aspect, further comprising performing entity resolution on the plurality of task locations prior to determining the distribution of capacity across the plurality of task locations.

According to a further aspect, the machine learning method of the second aspect or any other aspect, further comprising anonymizing the entity data to remove identifying information corresponding to the plurality of individuals associated with the entity.

According to a further aspect, the machine learning method of the second aspect or any other aspect, further comprising: A) determining differential data between at least two task locations of the plurality of task locations, wherein the differential data comprises a differential of a first parameter associated with one of the plurality of metric scores for each of the at least two task locations; and B) rendering a user interface comprising the differential data.

According to a third aspect, a non-transitory computer-readable medium embodying a program that, when executed by at least one computing device, causes the at least one computing device to: A) receive data describing at least one aspect of a position for an entity; B) generate metadata for the position based on the data describing the at least one aspect of the position, the metadata comprising a plurality of skills and tasks associated with the position; C) identify a plurality of task locations for the entity; D) determine a distribution of capacity across the plurality of task locations based on entity data for the entity, wherein the entity data comprising data describing a plurality of individuals associated with the entity; E) generate a plurality of metric scores comprising a collaboration score, a remote work score, an estimated remuneration range across each of the plurality of task locations; and F) generate a plurality of location scores for each of the plurality of task locations based on a weighing of each of the plurality of metric scores.

According to a further aspect, a non-transitory computer-readable medium embodying a program of the third aspect or any other aspect, wherein the program further causes the at least one computing device to generate at least one of the plurality of metric scores according to a step function.

According to a further aspect, a non-transitory computer-readable medium embodying a program of the third aspect or any other aspect, wherein the program further causes the at least one computing device to determine one or more coefficients associated with the step function based on the metadata.

According to a further aspect, a non-transitory computer-readable medium embodying a program of the third aspect or any other aspect, wherein the program further causes the at least one computing device to determine one or more interval associated with the step function based on the metadata.

According to a further aspect, a non-transitory computer-readable medium embodying a program of the third aspect or any other aspect, wherein the program further causes the at least one computing device to exclude a particular task location of the plurality of task locations based on a particular one of the plurality of metric scores falling below a predefined threshold.

According to a further aspect, a non-transitory computer-readable medium embodying a program of the third aspect or any other aspect, wherein the program further causes the at least one computing device to generate an overall location score by combining the plurality of location scores according to a predetermined weighting.

According to a further aspect, a non-transitory computer-readable medium embodying a program of the third aspect or any other aspect, wherein the program further causes the at least one computing device to compute the predetermined weighting for combining the plurality of location scores based on the metadata.

These and other aspects, features, and benefits of the claimed invention(s) will become apparent from the following detailed written description of the preferred embodiments and aspects taken in conjunction with the following drawings, although variations and modifications thereto may be effected without departing from the spirit and scope of the novel concepts of the disclosure.

### BRIEF DESCRIPTION OF THE FIGURES

The accompanying drawings illustrate one or more embodiments and/or aspects of the disclosure and, together with the written description, serve to explain the principles of the disclosure. Wherever possible, the same reference numbers are used throughout the drawings to refer to the same or like elements of an embodiment, and wherein:

FIG. 1 illustrates an exemplary recommendation system, according to one embodiment of the present disclosure;

FIG. 2 illustrates an exemplary location recommendation process, according to one embodiment; and

FIG. 3 illustrates an exemplary machine learning process, according to one embodiment.

### DETAILED DESCRIPTION

For the purpose of promoting an understanding of the principles of the present disclosure, reference will now be made to the embodiments illustrated in the drawings and specific language will be used to describe the same. It will, nevertheless, be understood that no limitation of the scope of the disclosure is thereby intended; any alterations and further modifications of the described or illustrated embodiments, and any further applications of the principles of the disclosure as illustrated therein are contemplated as would normally occur to one skilled in the art to which the disclosure relates. All limitations of scope should be determined in accordance with and as expressed in the claims.

Whether a term is capitalized is not considered definitive or limiting of the meaning of a term. As used in this document, a capitalized term shall have the same meaning as an uncapitalized term, unless the context of the usage specifically indicates that a more restrictive meaning for the capitalized term is intended. However, the capitalization or lack thereof within the remainder of this document is not intended to be necessarily limiting unless the context clearly indicates that such limitation is intended.

### Overview

Aspects of the present disclosure generally relate to machine learning-based solutions for evaluating and ranking location suitability for fulfilling a particular position or task.

### Exemplary Embodiments

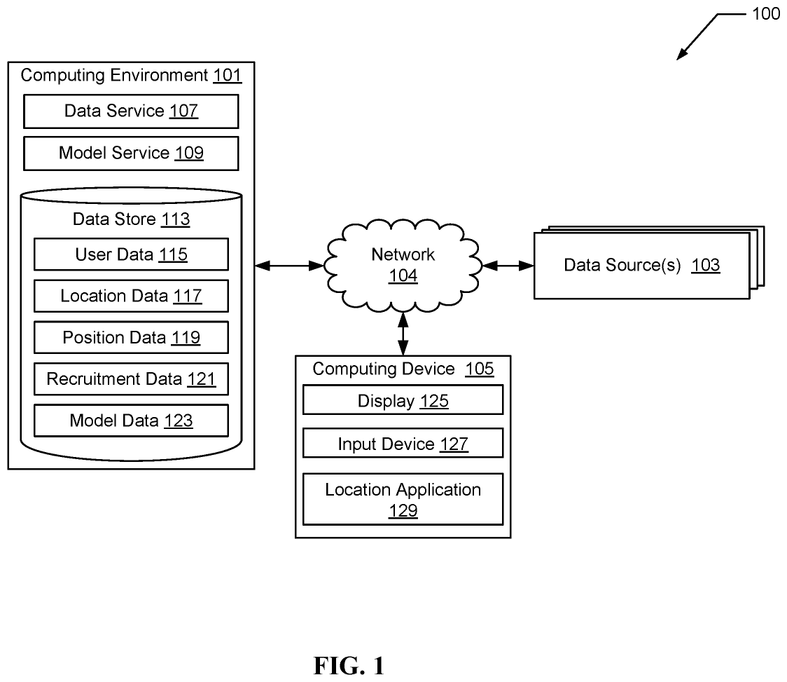

Referring now to the figures, for the purposes of example and explanation of the fundamental processes and components of the disclosed systems and processes, reference is made to FIG. 1, which illustrates an exemplary recommendation system 100. As will be understood and appreciated, the exemplary, recommendation system 100 shown in FIG. 1 represents merely one approach or embodiment of the present system, and other aspects are used according to various embodiments of the present system.

In various embodiments, the recommendation system 100 is configured to perform one or more processes for predicting the suitability of locations for filling a particular task, position, or responsibility. The recommendation system 100 may include, but is not limited to, a computing environment 101, one or more data sources 103, and one or more computing devices 105 over a network 104. The network 104 includes, for example, the Internet, intranets, extranets, wide area networks (WANs), local area networks (LANs), wired networks, wireless networks, or other suitable networks, etc., or any combination of two or more such networks. For example, such networks can include satellite networks, cable networks, Ethernet networks, and other types of networks.

According to one embodiment, the computing environment 101 includes, but is not limited to, a data service 107, a model service 109, and a data store 113. The elements of the computing environment 101 can be provided via a plurality of computing devices that may be arranged, for example, in one or more server banks or computer banks or other arrangements. Such computing devices can be located in a single installation or may be distributed among many different geographical locations. For example, the computing environment 101 can include a plurality of computing devices that together may include a hosted computing resource, a grid computing resource, and/or any other distributed computing arrangement. In some cases, the computing environment 101 can correspond to an elastic computing resource where the allotted capacity of processing, network, storage, or other computing-related resources may vary over time.

The data service 107 can be configured to request, retrieve, and/or process data from data sources 103. In one example, the data service 107 is configured to automatically and periodically (e.g., every 6 hours, 3 days, 2 weeks, etc.) collect job descriptions from a database of a recruitment agency or from a company website. In another example, the data service 107 is configured to request and receive skill and task information for one or more positions from a career accreditation or certification website. In another example, the data service 107 is configured to receive location data that defines one or more qualities of a particular location, such as average income, housing availability, cost of living, population density, traffic patterns, public transit availability, universities, and talent density for one or more disciplines (e.g., software development, data science, etc.). In another example, the data service 107 is configured to receive proprietary market analyses from a privileged database.

The data service 107 can be configured to monitor for changes to various information at a data source 103. In one example, the data service 107 scrapes public websites to monitor for changes to location data of one or more locations. In another example, the data service 107 monitors for changes to job postings for a plurality of company accounts on a social networking recruitment website. In another example the data service 107 monitors for changes to a plurality of office profiles at a company database. In this example, the data service 107 detects that an estimated onboarding time of a particular office has changed from “2-3 weeks” to “1-2 months.” Continuing this example, in response to the determination, the data service 107 automatically collects the new location information, which may be stored in the data store 113.

In various embodiments, the data service 107 is configured to perform analyses of various data, and the data service 107 may coordinate with the model service 109 to perform one or more analyses (e.g., the data service 107 may call the model service 109 to execute various functions). In one example, the data service 107 commands the model service 109 to analyze a job description input including a plurality of skills and tasks, analyze historical job data from one or more databases, generate associations between the plurality of skills and tasks and one or more historical job positions, and generate associations between one or more historical skills or tasks and the job description. In another example, the data service 107 determines a distribution of talent across a company's office locations (e.g., talent for a position title or position duties) by parsing employee information via public records searches or other databases, or through data provided by a user. In one embodiment, the distribution of talent determination may reveal whether a particular office location has a high or low existing amount of talent for the position or position description.

The data service 107 can be configured to determine likely categories or bins for various data. The data service 107 can utilize classifications and bins to determine additional relevant information that may limit or otherwise influence geographic options for fulfilling a position. As an example, the data service 107 determines that the skills and tasks “building APIs, Java, Scala, C#” fits into a bin for “software development, backend.” In some embodiments, the data service 107 can use natural language processing (NLP) to assign bins to various skills and tasks. As an example, the data service 107 can convert each of the skills and tasks into multi-dimensional vectors, and identify a closest bin based on a distance to multi-dimensional vector or areas corresponding to each bin. In some embodiments, the vectors for various bins can be tuned as new skills and tasks are assigned to the bin. Further, based on the classification, the data service 107 can match the skills and tasks to historical job positions, and the data service 107 can determine additional position metadata based on the historical job positions, such as backend web development certifications, alma maters, tenure, and performance ratings. In another example, the data service 107 analyzes a job description for a project manager position and determines that a salary range of “$140,000-170,000” fits into a middle level-bin for the salary range being a “3 of 5 level.” In the same example, based on the classification, the data service 107 matches the job description to historical position data for project manager positions at a plurality of locations. Continuing the example, based on the historical position data, the data service 107 generates additional metadata for use in generating location recommendations, such as historical salary trends, estimated requirements for remote worker expenses, housing costs, transportation costs, and proximity to talent pools (e.g., universities, competitors, etc.).

In some embodiments, the data service 107 is configured to perform one or more actions, for example, in response to input received from a computing device 105. In one example, in response to a request for information on a particular location, the data service 107 analyzes historical location data 117 and position data 119 and determines position titles, types, and tasks that were filled at the particular location. In this example, the position titles, types, and tasks are displayed at a computing device 105 from which the request is received. In another example, the data service 107 identifies and transmits location criteria demonstrated by one or more locations that filled a position or task. In this example, the location criteria can provide a user with an overview of exemplary location qualities and other information that may be relevant to staffing processes for other employment sources, organizations, or positions (e.g., which may be similar or dissimilar to those with which the location criteria is associated). In some example, the location criteria can include a weighted scoring system, and the data service 107 can the location criteria by performing iterative regression analysis on the historical location data 117 and position data 119 to identify correlations in the data. In some embodiments, the data service 107 can use machine learning to identify optimal location criterial based on the historical location data 117 and position data 119. In another example, the data service 107 receives a request to evaluate a particular location for a particular position title, type, or task. In this example, the data service 107 retrieves location data 117 (and/or other data) with which the particular location is associated and compares the location data 117 to historical data with which the position titles, task, or type (or similar positions) are associated. Continuing the example, based on the comparison, the data service 107 determines one or more deficiencies in criteria of the particular location that, when filled, may increase the suitability of the particular location for filling the position title, type, or task. In the same example, the one or more deficiencies are displayed on the computing device 105.

The model service 109 can be configured to perform various data analysis and modeling processes. The model service 109 can generate, train, and execute neural networks, gradient boosting algorithms, mutual information classifiers, random forest classification, and other machine learning and related algorithms. In at least one embodiment, outputs generated by the model service 109 may be binary (e.g., exemplary predictions being “location A is a suitable location for job position X” and “location B is not is not a suitable location for job position X”), or may be correlated to a scale (e.g., exemplary predictions being “location A is more likely suited for filling job position X” and “location B is less likely suited for filling job position X”). In one or more embodiments, outputs may be formatted as classifications determined and assigned based on comparisons between prediction scores (generated by machine learning models) and prediction thresholds that may be predefined and/or generated according to one or more machine learning models.

In one example, the model service 109 generates and trains machine learning models for recommending one or more optimal locations from which to hire one or more persons for a position or task. In this example, the machine learning models can generate metric scores for various input data types (e.g., work scores, talent scores, collaboration scores, remote work scores, location scores, etc.), and the machine learning models can generate rankings of hiring location or talent pool suitability based on the metric scores. In another example, the model service 109 generates and trains machine learning models for classifying job descriptions (e.g., or information derived therefrom) into one or more categories or bins.

In various embodiments, the model service 109 determines the degree of collaboration a job position may entail. In one or more embodiments, the model service 109 generates a recommendation for whether a position should be remote based or in person. The model service 109 can evaluate collaboration and remote work according to one or more embodiments described in U.S. Patent Application No. 63,035,379, filed Jun. 5, 2020, titled “COLLABORATION INDEX” or U.S. Patent Application No. 63,035,372, filed Jun. 5, 2020, titled “REMOTE ROLE RECOMMENDATION ENGINE,” the disclosures of which are incorporated herein by reference in their entireties.

The model service 109 or data service 107 can be configured to perform various data processing and normalization techniques to generate input data for machine learning and other analytical processes. Non-limiting examples of data processing techniques include, but are not limited to, entity resolution, imputation, and missing, outlier, or null value removal. In one example, the model service 109 performs entity resolution on location data for a plurality of locations to standardize terms such as position titles, company names, and task or skill descriptors. Entity resolution may generally include disambiguating manifestations of real-world entities in various records or mentions by linking and grouping. In one embodiment, a dataset of entity data may include a plurality of titles for a single position, and the model service 109 can perform entity resolution to associate the titles with the position. In one or more embodiments, the system may perform entity resolution to identify data items that refer to the same employer, but may use variations of the employer's title or different entity names owned by or controlled by the employer. In an exemplary scenario, a dataset may include references to an employer, Facebook, Inc.; however, various dataset entries may refer to Facebook, Inc. as Facebook™, Facebook, Inc., Instagram, WhatsApp, Onavo, Beluga, Facebook.com, and other variants. In the same scenario, an embodiment of the system may perform entity resolution to identify all dataset entries that include a variation of Facebook, Inc., and replace the identified dataset entries with the standard employer name Facebook, Inc.

The data store 113 can store various data that is accessible to the various elements of the computing environment 101. In some embodiments, data (or a subset of data) stored in the data store 113 is accessible to the computing device 105 and one or more external systems (e.g., on a secured and/or permissioned basis). Data stored at the data store 113 can include, but is not limited to, user data 115, location data 117, position data 119, recruitment data 121, and model data 123. In various embodiments, any of the user data 115, location data 117, position data 119, and recruitment data 121 are generally referred to as “entity data.” The data store 113 can be representative of a plurality of data stores 112 as can be appreciated.

The user data 115 can include information associated with one or more user accounts. For example, for a particular user account, the user data 115 can include, but is not limited to, an identifier, user credentials, and settings and preferences for controlling the look, feel, and function of various processes discussed herein. User credentials can include, for example, a username and password, biometric information, such as a facial or fingerprint image, or cryptographic keys such as public/private keys. Settings can include, for example, communication mode settings, alert settings, schedules for performing machine learning and/or communication generation processes, and settings for controlling which of a plurality of potential data sources 103 are leveraged to perform machine learning processes.

In one example, the settings include a configuration parameter for a particular position location or region. In this example, when the configuration parameter is set to a particular region, a machine learning and/or natural language generation process can be adjusted to account for a work culture or other set of factors with which the particular region is associated. Various regions and sub-regions of the world may demonstrate varying work cultures. Because work culture may vary, data that is useful in generating effective location recommendations may also vary, in addition to variances in magnitudes of impact and impact directionality imposed on machine-learned predictions.

In one example, work culture of a first region is such that individuals in the region typically work a 35-hour work week, and work culture of a second region is such that individuals in the region typically work a 50 hour work week. In this example, the computing environment 101 receives a user input defining a minimum number of hours for a position of about 40 hours and, in response, the model service 109 configures a setting that excludes locations in the first region from subsequent staffing recommendations. In another example, the computing environment 101 can identify other criteria for the job positions, such as that the job position involves an average of 45-50 hours per week based on position data 119 and other data including entity data describing individuals associated with the entity (e.g., employees, contracted hires, etc.). The computing environment 101 can exclude locations based on location data failing to meet the determined criteria.

In another example, work culture of a particular region may be such that employees typically remain with their company for an extended time period (e.g., decades, as compared to years in other work cultures). In this example, the model service 109 may assign a greater weight level to location criteria defining whether a particular location in the region includes existing pools of talent (e.g., locations where employees have remained with the company for longer periods). In various embodiments, the system may configure one or more machine learning and/or NLP processes to account for variations in work culture. For example, the system may alter one or more machine learning parameter weights to reduce an impact or change impact directionality on likelihood predictions. In the above example, the system may reduce machine learning parameter weights and/or modify parameter impact directionality for parameters including onboarding time, job latency, and job tenure, thereby reducing the parameters' impact on subsequently generated likelihood predictions.

The location data 117 can refer to information associated with one or more locations from which labor may be recruited. The location data 117 can include, but is not limited to, addresses for offices and other job sites, economic data associated with a particular location (e.g., housing costs, cost of living, mortgage rates, etc.), academic data associated with a particular location (e.g., average level of education, prevalence of various degrees, proximities of universities, etc.), and rules, codes, regulations, and laws associated with a particular location (for example, laws governing minimum wage, hiring quotas, benefits, etc.). The location data 117 can include weather data, crime statistics, traffic statistics, environmental data, and talent pool distribution across various tasks, skills, and job titles. The model service 109 or data service 107 can normalize various fields in location data 117, such as, for example, generating binary values “yes” or “no” values for specific rules, codes, regulations, and laws (e.g., whether minimum wage is above or below a threshold).

The position data 119 can refer to data associated with employment opportunity and fulfillment information. Position data 119 can include, but is not limited to, position titles, position duties, responsibilities, and tasks. Position data 119 may include position locations, such as, for example, a list of current and previous addresses to which candidates holding a position have been located. Position data 119 may include position fulfillment history, such as, for example, past and current position holders, position providers (e.g., institutions, companies, etc. that offer or provide labor filling particular positions), salary and/or wage information, position reviews, position provider reviews, and resumes, C.V.'s, or the like, of past and current position holders. Position data 119 may include past and current position holder education histories, job satisfaction (for example, job and/or workplace reviews related to any number of current or past-held positions), age, family status(es), marital status(es), past and current debt obligations, past and current financial health, (for example, a credit score), and social media activities. In some embodiments, the recommendation system 100 is configured to process a position holder's resume and/or employee files and determine various position data 119, such as a work history, education history, and location history. The model service 109 or data service 107 can normalize various fields in position data 119, such as, for example, adjusting title descriptions to match a predetermined title (e.g., “Sales Manager I” and “Manager of Sales I” can be adjusted to both correspond to the same position code or title).

The recruitment data 121 can refer to data associated with an employment opportunity, such as a desired set of experiences or other criteria. In one example, the recruitment data 121 includes candidate criteria, such as desired experience (e.g., skills and/or work history), location, education, compensation history and/or requirements, and other candidate qualifications. In another example, the recruitment data 121 includes location criteria defining one or more desired qualities or properties of a location from which labor may be recruited.

The recruitment data 121 can include data describing one or more candidates (e.g., generally referred to as “candidate data”). The candidate data can include, but is not limited to, candidate names, location tracking data, such as, for example, a list of current and previous addresses, education history, job satisfaction (e.g., job and/or workplace reviews), age, family status, marital status, debt obligations, financial health (for example, a credit score), and social media activities (e.g., such as a list of followers, postings, etc.). In one example, candidate data includes work history, such as past and current job titles, positions, roles, employers, salary and/or wage information, candidate performance reviews, job locations, and resumes. In at least one embodiment, personally identifying data, financial data, social media data, and other personal data (e.g., family and marital status, etc.) may not be collected or leveraged or may be intentionally excluded for processes described herein (e.g., in accordance with legal policy, corporate policy, data privacy policy, user consent parameters, etc.). In some embodiments, candidate data includes criminal records, degree history, liens, voting history, and other data obtained from investigative processes (e.g., such as information obtained from a background check performed on a particular candidate). The candidate data can include assets owned by candidates including timing information as to when those assets were purchased, such as, for example, real estate including primary residences and secondary residences, vehicles, boats, planes, and other assets. The candidate data can include current estimated values and debts associated with each asset. The model service 109 or data service 107 can normalize various fields in recruitment data 121, such as, for example, normalizing background check information to fit into predetermined bins (e.g., whether a candidate has a criminal record, whether a candidate's credit score is above a predetermined threshold, whether the candidate attended a university ranked at or above a predetermined threshold).

The model data 123 can include data associated with machine learning and other modeling processes described herein. Non-limiting examples of model data 123 include, but are not limited to, machine learning models, parameters, weight values, input and output datasets, training datasets, validation sets, configuration properties, and other settings. In one example, model data 123 includes a training dataset including known outcomes (e.g., classifications, location scores, additional metric scores) of a plurality of locations. In the same example, the training dataset includes historical location data 117, recruitment data 121, and position data 119 associated with the locations and known outputs. In this example, the training dataset can be used for training a machine learning model to estimate one or more optimal locations from which an entity may fill a position or task.

In various embodiments, the model data 123 may include work culture categories that can be provided as an input to machine learning processes. In at least one embodiment, a work culture category may be used by the modeling service 109 to modify data that is input to and analyzed via one or more machine learning models. In one embodiment, a work culture category may be used by the modeling service 109 to modify outputs generated by one or more machine learning models. For example, a work culture category associated with a work culture that utilizes a Sunday-Thursday work week may cause a machine learning model to downgrade or reduce recommendation scores for locations associated with the work culture category. In one embodiment, the data stored in the data store 113 can exclude specific types of information from being used in analyses to ensure fair and equal treatment, e.g., to avoid excluding someone based on marital status, gender, race, sexual preference, etc.

In one or more embodiments, a work culture category may be used by the modeling service 109 to cause one or more machine learning models to initialize parameter weights at a higher or lower magnitude, or with a positive or negative directionality. For example, a work culture category for a “Country X” may be input to a machine learning process for identifying optimal locations from which to hire for a particular position. In the same example, the Country X work culture category may cause one or more machine learning models to exclude input data related to traffic patterns, visa fees, and average education when analyzing locations from Country X (e.g., establishing that traffic patterns, visa fees, and average education are not predictive for identifying optimal staffing locations in Country X). Continuing with this example, the Country X work culture category may also cause the one or more machine learning models to establish a positive impact directionality on parameters and data related to an experience level and skill levels (e.g., establishing that a greater experience level and skill level makes locations from Country X more likely to be optimal staffing locations). In some embodiments, the model service 109 identifies utilities available at the location or country, such as availability of raw materials, available Internet speeds, external temperatures/weather, available tax benefits, etc.). As an example, the model service 109 may weigh, for a job position to construct a data center, a first factor for a first location that has a cooler average temperature higher than a second location that has a higher average temperature.

In various embodiments, the data source 103 can refer to internal or external systems, pages, databases, or other platforms from which various data is received or collected. Non-limiting examples of data sources 103 include, but are not limited to, human resources systems, recruitment systems, real estate and other housing information systems, resume processing systems, applicant and talent pools, public databases (e.g., commercial record systems, tax systems, criminal record systems, company information databases, university systems, social media platforms, and etc.), private and/or permissioned databases, webpages, and financial systems. In one example, a data source 103 includes a social networking site for professional development from which the computing environment 101 collects and/or receives job descriptions and related information (e.g., such as information relating to a company associated with the job description or similar job descriptions). In another example, a data source 103 includes a geolocation service from which the computing environment 101 retrieves addresses and other location data. In another example, a data source 103 includes a database of rules, such as a corpus of active codes, regulations, and laws for a particular location.

The computing device 105 can be any network-capable device including, but not limited to, smartphones, computers, tablets, smart accessories, such as a smart watch, key fobs, and other external devices. The computing device 105 can include a processor and memory. The computing device 105 can include a display 125 on which various user interfaces can be rendered by a location application 129 to configure, monitor, and control various functions of the recommendation system 100. The location application 129 can correspond to a web browser and a web page, a mobile app, a native application, a service, or other software that can be executed on the computing device 105. The location application 129 can display information associated with processes of the recommendation system 100 and/or data stored thereby. In one example, the location application 129 displays location profiles that are generated or retrieved from the data store 113. In another example, the location application 129 displays a ranked list of locations classified as “Most Optimal” or, in another example, displays a ranked list of location qualities that most positively and negatively contributed to a machine learning model output.

The computing device 105 can include an input device 127 for providing inputs, such as requests and commands, to the computing device 105. The input devices 127 can include a keyboard, mouse, pointer, touch screen, speaker for voice commands, camera or light sensing device to reach motions or gestures, or other input devices. The location application 129 can process the inputs and transmit commands, requests, or responses to the computing environment 101 or one or more data sources 103. According to some embodiments, functionality of the location application 129 is determined based on a particular user account or other user data 115 with which the computing device 105 is associated. In one example, a first computing device 105 is associated with a company user account and the location application 129 is configured to display location profiles and provide access to location evaluation and recommendation processes. In this example, a second computing device 105 is associated with an office user account or a candidate user account, and the location application 129 is configured to allow the computing device 105 to transmit location data 117 and position data 119 to the computing environment 101 and to display communications, such as staffing messages and alerts.

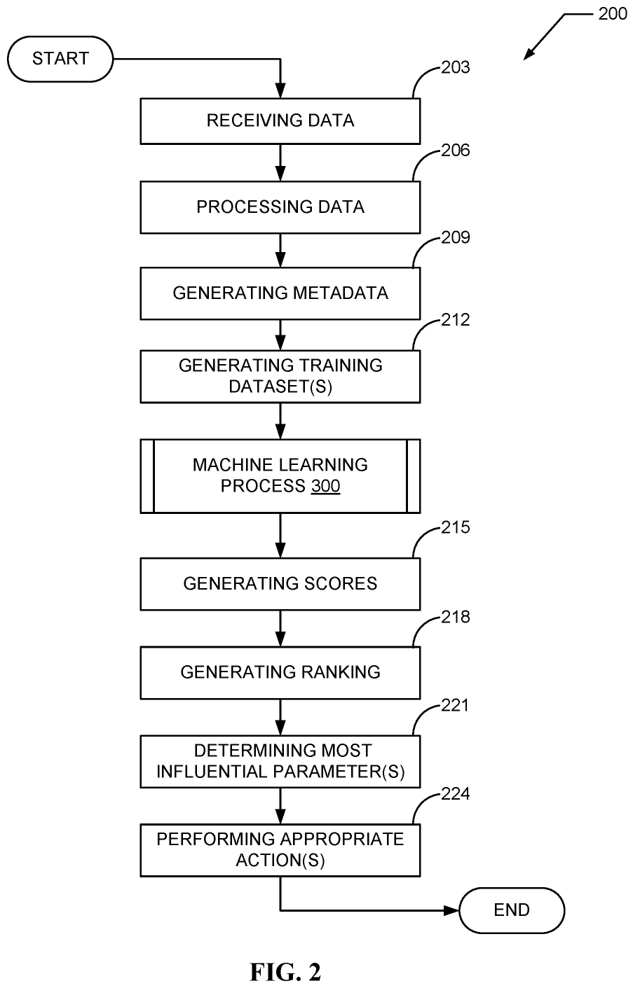

FIG. 2 shows an exemplary location recommendation process 200. As will be understood by one having ordinary skill in the art, the steps and processes shown in FIG. 2 (and those of all other flowcharts and sequence diagrams shown and described herein) may operate concurrently and continuously, are generally asynchronous and independent, and are not necessarily performed in the order shown.

At step 203, the process 200 includes receiving data. As an example, the data service 107 can receive data include receiving, collecting, extracting, or obtaining data from one or more computing devices 105, data sources 103, or the data store 113. In various embodiments, the system may receive data by processing electronic documents, web pages, and other digital media from data sources 103. In one example, the data service 107 receives resumes, position descriptions, online reviews, and other digital media to obtain data that may relate to a job description (e.g., or to a position, task, skill, or title described therein).

In various embodiments, the data service 107 may receive a job position that contains a job description for the data service 107 to recommend one or more locations that the company should hire from for that job position. The job position can be received from a user or computing device. In one or more embodiments, a user may be a person within a company that posts job positions, or may be a system associated with a company. In one example, the data service 107 receives a job description from a computing device 105 via the location application 129. In at least one embodiment, the data service 107 receives a job title, the name of the company hiring for the job position, and a job description. In various embodiments, the job description includes, for example, a job title, company name, required skills, tasks to be performed, expected responsibilities, job location (e.g., including whether the job was at a specific job site or could be performed remotely or near remotely), and information that may be relevant to staffing the position. In one example, the job description includes a list of tasks and responsibilities for the job position and other criteria, such as, for example, a salary range (or other remuneration range, such as a salary and benefits range), and desired certifications.

In one or more embodiments, receiving data includes automatically (e.g., or in response to input) collecting, retrieving, or accessing data from one or more data sources 103. In at least one embodiment, the data service 107 may automatically scrape and index publicly accessible data sources to obtain job position data and/or other information. In one example, the data service 107 detects an upload of a job description to a company page on a job posting website. The data service 107 automatically collects the information for the job description and initiates the process 200 to generate a ranked list of locations from which to recruit for the posted job. In another example, the data service 107 detects an upload of a webmaster recruitment post to a company website, and the data service 107 automatically scrapes the job description and the company website to recommend an optimal office location from a plurality of office locations for which to hire the web master. The data service 107 can periodically and automatically spider or crawl over websites that include job postings to identified posted jobs and collect the data.

In one or more embodiments, the data service 107 may collect, retrieve, or otherwise access job position data (and other relevant information) for determining whether there is a degree of collaboration associated with a job position (e.g., which may influence a determination of an optimal office location), and for determining whether a position may be performed remotely. In at least one embodiment, the data service may automatically process current and historical job position data stored in one or more databases to generate location, collaboration, and remote predictions described herein.

At step 206, the process 200 includes processing the data of step 203 and/or additional data, such as, for example, historical data from the data store 113 or data from data sources 103. The system can process data including, but is not limited to, performing text recognition and extraction techniques, data normalization techniques (e.g., such as data imputation or null value removal), entity resolution techniques, and/or (pseudo-)anonymization techniques. In at least one embodiment, processing the data includes anonymizing or pseudo-anonymizing personally-identifying information (PII). In one example, the data service 107 processes position information scraped from a company's public social media profile. In this example, the data service 107 can recognize key information and terms, such as, for example, tasks and skills for the position, position qualifications, estimated salary, company locations, and other suitable information that may influence the prediction of optimal locations from which to fill the position.

In at least one embodiment, processing the data includes performing entity resolution to group and disambiguate values in the data for purposes of enabling or improving analyses of the processed data. As described herein, entity resolution may generally include disambiguating manifestations of real world entities in various records or mentions by linking and grouping. In one example, a dataset of job position data may refer to a relation between labor supply and labor demand as supply-demand ratio, supply-demand coefficient, and supply-demand score. In this example, the data service 107 performs entity resolution to determine the descriptors refer to the same measure and to replace the descriptors terms with a common term (e.g., “supply-demand ratio,” or another suitable term). In one or more embodiments, supply generally refers to a location's supply of talent (e.g., talent being based on information provided and inferred about the skills, experience, and other criteria desired for the job position). In at least one embodiment, demand is the demand for talent that has those skills and experience based on aggregated and parsed job postings scraped on the internet.

In another example, the data service 107 processes a job posting and identifies a job title, tasks, responsibilities, desired experience, certifications, computer programs utilized, and company name. In the same example, the data service 107 performs an entity resolution process to replace titles and roles in the work history with industry-standardized positions.

At step 209, the process 200 includes generating metadata corresponding to a job description or locations from which the described job may be filled. In one or more embodiments, the data service 107 generates metadata from the job description based on natural language processing techniques, such as, for example, keyword matching and/or topic modeling. In one example, the data service 107 performs keyword matching on a job description to identify and classify subsets of the job description that describe skills, tasks, responsibilities, desired experience, pay, and other aspects of the position.

In one or more embodiments, the data service 107 and/or the model service 109 uses the data of steps 203-206 to determine additional relevant information, such as, for example, historical job functions and job levels, industry of the company, office locations of the company, an existing distribution of talent within the company, or a concentration of talent within a particular location. In at least one embodiment, the data service 107 identifies office locations within a company by using the company name to search public records. In various embodiments, the data service 107 identifies a company that is hiring for a position by utilizing natural language processing techniques on the corresponding position description. In some embodiments, the data service 107 system determines a company name from a data source 103 associated with the company that provided the initial job position data. In one or more embodiments, in response to determining the company's, or other entity's, name, the data service 107 may determine the operating locations of the company by parsing through public records databases or other databases.

Additional, non-limiting examples of metadata include regional salary estimates and trends, supply to demand ratios for a particular location and/or position, talent metrics for a particular location (e.g., measures of academic achievement, productivity, tenure, etc.), talent pool growth rate, historical levels of engagement from one or more locations (e.g., tentative locations of labor pools, existing company locations, etc.), historical measures of time required to fill a role, and historical onboarding expenses. In one example, the data service 107 receives only a job description and uses one or more machine learning algorithms to determine additional job metadata for the job description. In the same example, the data service 107 attaches the additional job metadata to the job description (e.g., or otherwise associates the job metadata with the job description in the data store 113).

In at least one embodiment, generating the metadata includes parsing historical data from the data store 113 and generating associations between one or more subsets of historical data and the current job description. For example, the data service 107 can compute a talent density metric for a particular location by analyzing historical hiring data for a plurality of locations (e.g., including the particular location) and determining a comparative distribution of talent throughout the plurality of locations. In another example, the data service 107 determines company metadata including a list of company office locations from a company's job posting. In the same example, for each office location the data service 107 determines additional metadata including access to high speed internet (e.g., based on current and/or historical download and upload speeds for the corresponding location), proximity to airports, and adjusted cost of living.

In some embodiments, the disclosed system may use the data from the job description (e.g., and/or metadata derived therefrom) to determine additional relevant information via machine learning algorithms and natural language processing, by utilizing additional resources such as standard occupation codes, ONET codes, or other standards, for formalizing the structure and modeling of the job position looking to be filled. For example, in one embodiment, a job description may only contain a position title, wherein the data service 107 may parse through stored information in proprietary databases and/or publicly available databases containing job position data, such as the additional resources from above, to determine the skills, tasks, and responsibilities for the job position. In one or more embodiments, the data service 107 may also determine the industry of the company from the company name, by parsing through public records and utilizing natural language processing techniques.

In some embodiments, generating the metadata includes parsing proprietary databases and/or public databases to determine job metadata for a given job description or job position. For example, in one embodiment, the data service 107 may receive a job description that includes three tasks and/or responsibilities for the job position. Continuing with the example, the data service 107 may parse a proprietary database containing stored historical job position data, and the data service 107 matches the original tasks/responsibilities to one or more historical job positions. In the same example, the data service 107 and attach additional tasks/responsibilities from the historical job position data to the current job description.

At step 212, the process 200 includes generating one or more training datasets. Generating a training dataset can include retrieving the training dataset from model data 123. In at least one embodiment, the model service 109 and/or the data service 107 generates the training dataset by indexing historical outcomes (e.g., historical hiring and staffing data) with corresponding, historical location data 117, position data 119, recruitment data 121, and other entity data. In various embodiments, the model service 109 generates or receive training sets for training machine learning models to generate one or more predictions (e.g., in the form of scores and/or classifications).

In at least one embodiment, the model service 109 generates job position training sets for predicting a ranking of locations from which a company should hire a specific job position. For example, the model service 109 generates, or retrieves from the data store 113, a job position training set including data describing known locations for hiring certain job positions. In the same example, the model service 109 uses the job position training set to generate and train one or more machine learning models to accurately and precisely predict a likelihood of a job position being filled at a specific location or being filled by a remote worker.

In another example, the model service 109 generates a training data set that includes a plurality of locations, and includes historical location data, historical job fulfillment data, and historical job performance data associated with each of the plurality of locations (e.g., and also associated with a particular job or task performed at each of the plurality of locations). In this example, the model service 109 uses the training dataset to train one or more machine learning models to classify locations into varying levels of suitability as hiring sources for a particular position or task. In various embodiments, training data sets can include labeled outcomes for improving precision and accuracy of one or more machine learning models (e.g., by allowing experimental machine learning model outputs to be compared to an accurate baseline and by optimizing the one or more machine learning models based on the comparison). In one example, the model service 109 generates

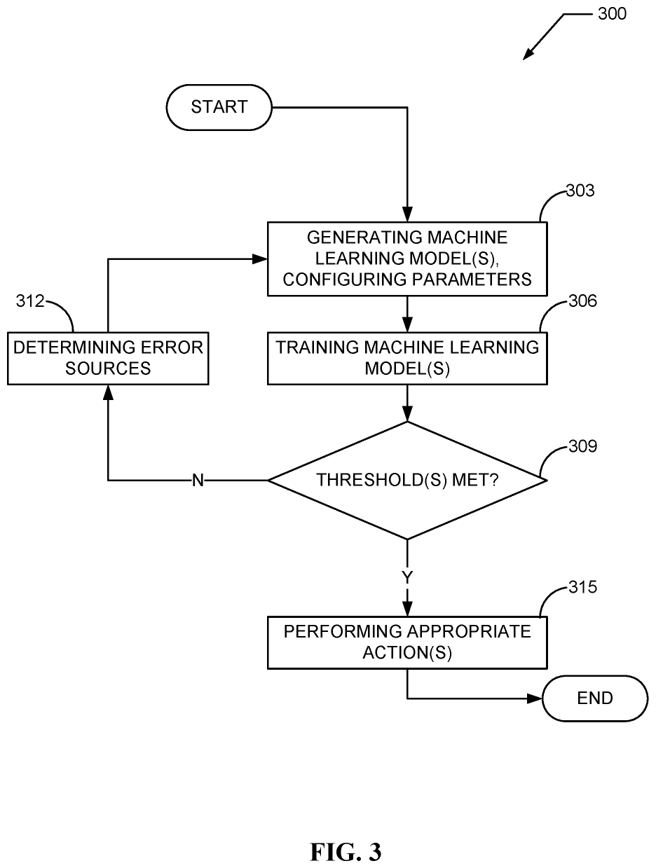

In various embodiments, the process 200 includes performing one or more machine learning processes 300 (FIG. 3) to generate one or more machine learning models for performing analyses and generating outputs described herein. According to one embodiment, following generation of one or more training sets at step 212, the process 200 includes performing the machine learning process 300 to generate and train one or more machine learning models to determine an optimal location (e.g., or a ranking of optimal locations) from which to fill a position described in the data received at step 203. In one example, an output of the machine learning process 300 includes a trained machine learning model that generates a location score for each of a plurality of locations based on an analysis of a job description and additional information corresponding to the particular location. In the same example, the trained machine learning model is trained to classify each plurality of locations as “most likely to be suited for filling the position,” “more likely to be suited for filling the position,” “likely to be suited for filling the position,” “less likely to be suited for filling the position,” “unlikely to be suited for filling the position,” and “least likely to be suited for filling the position” based on the corresponding location scores.

At step 215, the process 200 includes generating one or more location scores. According to one embodiment, the location score refers to a metric describing a location's suitability for filling a job or task. In various embodiments, generating the one or more location scores includes executing one or more trained machine learning models on the entity data received at step 203 and/or additional data and metadata derived therefrom at steps 203-209.

In some embodiments, step 215 includes generating additional metrics (for example, additional scores) that may be weighted and combined to generate an overall location score. The system can combine location scores to generate the overall location scores. As an example, the system can use predetermined weightings to combine the location scores into the overall location scores. In some embodiments, the system can determine weightings for combining the location scores. In other embodiments, the system can receive user configurable weightings for use in combining the locations scores. In some embodiments, the system can determine weightings for combining the location scores. The system can customize the weightings for each particular job description using metadata. As an example, the system can generate a greater weighting for expected salary at the location when a salary of a posted job position includes a salary range (also referred to as a “remuneration range”) that is below an average market rate for the job title.

In one or more embodiments, the additional metrics may include, but are not limited to, a collaboration score, a remote work score, the engage-ability of the talent pool (e.g., that may be derived from engage scores), an estimated salary range, a projected salary trend, a talent supply to demand ratio, an estimated time to fill role, a talent pool growth rate, access to high speed internet, proximity to airport, requirements for reimbursement for remote worker expenses, business environment impacts based on state and local tax laws and other relevant employment laws, and other business needs or requirements that may limit the geographic options for the job position. In various embodiments, the model service 109 computes an overall location score based on weighted combinations of each factor. In at least one embodiment, the model service 109 weighs each individual factor based on an importance of the factor for the position (e.g., or for determining an optimal location for the position). In one example, in response to the model service 109 determining that a job position has a high remote work score (e.g., meaning that the job could be “fully remote”), the model service 109 assigns a greater weight an “access to high speed internet” factor and associated metric score (e.g., because it may be beneficial for remote workers to have high speed internet).

In another example, in response to the data service 107 determining the job position is estimated to be filled in four weeks at “Office Location A” and in six weeks at “Office Location B,” the model service 109 assigns “Office Location A” a better metric score for the additional factor of “estimated time to file role.” As another example, if the model service 109 determines that a talent pool at “Office Location B” has a higher engage-ability than the talent pool at “Office Location A,” the model service 109 assigns a better metric score to Office Location B for additional factor of “engage-ability of the talent pool.”

In at least one embodiment, generating the location scores includes calculating a cost for each additional factor for each candidate location, via machine learning or other process(es). In some embodiments, a metric score for each additional factor refers to the calculated cost for the additional factor. In one or more embodiments, an overall location score is a total of the costs for each additional factor associated with hiring a person for the candidate location. In various embodiments, a cost refers to a direct cost or an indirect cost. In some embodiments, a direct cost may be generally defined and/or measured in terms of monetary value, such as, but not limited to, the salary for a certain job position. In at least one embodiment, the data service 107 and/or the model service 109 estimate the direct cost of an additional factor by using stored aggregated data associated with the direct cost. In various embodiments, the data service 107 and/or the model service 109 estimates the direct cost of an additional factor by using predictive modeling that may utilize additional direct costs factors, such as, for example, the rate of inflation, historical trends, and anticipated discounts (e.g., from other businesses, from government policies, etc.).

In one or more embodiments, an indirect cost may be generally defined and/or measured in terms of monetary value, such as, for example, access to high speed internet or the time to fill a position. In several embodiment, the data service 107 and/or the model service 109 determines a monetary value equivalent for each indirect cost such that the additional factors associated with indirect costs may be factored into a total costs algorithm (e.g., potentially in combination with additional direct costs). In one example, a certain location may lack high speed internet (e.g., maximum upload and download speeds are less than 5 MB/s), which may cause a person hired in that location to be less productive. In example, the data service 107 and/or the model service 109 utilize machine learning processing or other estimation tools to determine a monetary value equivalent of the indirect cost of lacking high speed internet in the certain location. Continuing the example, the model service 109 determines a total location score at least partially based on the estimated direct cost of low speed internet and additional direct costs factors. In some embodiments, if the model service 109 determines that a particular location demonstrates a total costs (e.g., or cost differential, such as a significant increase as compared to other candidate locations), the model service 109 automatically classifies the location as “less likely to be suitable” or generates a lower overall score for the location.

In at least one embodiment, a collaboration score is a determination of how collaborative the job position may be with other members of the company. In one or more embodiments, the collaboration score may be based on the user's input in the initial job description, or the disclosed system may determine, via one or more machine learning algorithms, how collaborative a job position or job description may be for a given set of factors. In at least one embodiment, the data service 107 receives a collaboration classification input in the job description of the job position, and the data service 107 uses natural language processing and machine learning to determine the collaboration score based on the collaboration classification. For example, in one embodiment, a user may input that a job includes “working with other team members on a daily basis,” and the data service 107 and model service 109 may process the phrase and determine that the position is highly collaborative, thereby causing the model service 109 to assign a collaboration score to the job position. In an alternate embodiment, the disclosed system may evaluate how collaborative a job position may be, wherein the input may be a collaboration classification, such as “highly collaborative,” or the input may be collaboration score, which may be a numerical number.

In at least one embodiment, the computing environment 101 receives a collaboration classification input from the user in the job description and independently determines a collaboration score or collaboration classification via machine learning models (e.g., based on the input data, job metadata, and/or other factors). In one or more embodiments, the model service 109 uses both collaboration score types to generate a location recommendation for the job position. In some embodiments, the model service 109 prioritize one collaboration score over the other collaboration score based on availability, predictive power, user preference, or other factors or preferences.

In various embodiments, a remote work score is a determination of whether the job position may be performed remotely, partially remotely, or on-site, or another suitable remote working classification. In one or more embodiments, the remote work score is based on a user's input in the initial job description and/or derived from one or more processes performed by the data service 107 and/or the model service 109. In at least one embodiment, the user may input a remote work classification in the job description of the job position, and the data service 107 and the model service 109 may use natural language processing and machine learning to determine the remote work score. In one example, in one embodiment, the data service 107 receives a user input indicating that the job position “may be done from home a few days a week,” and the data service 107 may process the phrase and determine that the position is partially remote. In the same example, the model service 109 assigns a remote work score to the job position based on the extracted phrase. In another example, based on historical location data 117 and position data 119 the model service 109 estimates whether a job position may be capable of being done remotely, wherein the input may be a remote work classification, such as “fully remote,” or the input may be a remote work score, which may be a numerical score.

In at least one embodiment, the computing environment 101 extracts a remote work classification input from the job description, and the computing environment 101 also independently determines a remote work score or additional remote work classification based on the job description and associated data. In various embodiments, the model service 109 utilizes both extracted and estimated remote work scores in calculating the location recommendation for the job position. In some embodiments, the model service 109 prioritizes or weights a particular remote score based on user preference, machine learning factors, or other suitable factors or preferences.

The system can generate the scores based on a step function that includes multiple functions prescribed to different intervals of input values. As an example, a first function including one or more coefficients can be used when an input value is between an interval of 0 and 1, while a second function that includes one or more other coefficients can be used when an input value is greater than 1. The system can determine or adjust the coefficients for the step function based on metadata including skills and tasks associated with the position. The system can determine or adjust the intervals for the step functions based on metadata including skills and tasks associated with the position.

In some embodiments, the computing environment 101 estimates engage-ability according to one or more embodiments described in U.S. patent application Ser. No. 16/546,849, filed Aug. 21, 2019, titled “MACHINE LEARNING SYSTEMS FOR PREDICTIVE TARGETING AND ENGAGEMENT,” the disclosure of which is incorporated herein by reference in its entirety.

At step 218, the process 200 includes generating a location ranking based on the location scores of step 215 (e.g., or any other suitable source, such as scores stored in the data store 113). In one or more embodiments, the disclosed system may output a ranking, from best match to worst match, of the candidate locations, where the ranking is based on the overall location score. If the overall location score is based on the total costs for each additional factor associated with hiring a person for a certain office location, then, in one embodiment, the ranking may be based on lowest total costs, wherein the best match is the location that has the lowest total costs associated with hiring a person for the particular position.

In one or more embodiments, generating the ranking includes generating a classification of the location score based on Equation 1 (which can include e.g., a step function), in which h(x_{ijg}) is a machine-learned prediction from the one or more machine-learned predictions, h₀ is a predefined “suitable location” threshold, h₁ is a predefined “potentially suitable” threshold, h₂ is a predefined “likely suitable” threshold, and c(x_{ijg}) is the classification to which each one the one or more machine-learned predictions is assigned. In some embodiments, the process 200 only generates location scores and classifications, and does not generate a ranking.

$$c ( {x}_{ijg} ) = \{ \begin{matrix}location least likely to be suitable if h ( {x}_{i j g} ) \leq {h}_{0} \\ location may be suitable if {h}_{0} < h ( {x}_{i j g} ) \leq {h}_{1} \\ location more likely to be suitable if {h}_{1} < h ( {x}_{i j g} ) \leq {h}_{2} \\ location most likely to be suitable if h ( {x}_{i j g} ) > {h}_{2}\end{matrix} \qquad ( Equation 1 )$$

The computing environment 101 may utilize a user's preference of a particular location as an additional factor in determining location classifications. In various embodiments, the computing environment 101 uses the user's location preference as a “tie-breaker” such that the user's preferred candidate location is ranked ahead of other candidate locations with equal or similar overall location scores. The user's preferred candidate location can be retrieved from user data 115 or is received at step 203 (for example, as an input to the location application 129).

At step 221, the process 200 includes determining one or more parameters that were most influential to the output generated at step 215. In one or more embodiments, for each candidate location evaluated by a trained machine learning model, the model service 109 determines one or more parameters that were most negatively or positively impactful on the candidate location's associated location score (or other prediction) and, thus, on the candidate location's classification. In one example, for a location classified as “more likely to be suitable,” the model service 109 analyzes model data 123 associated with the location's classification to determine one or more most influential parameters. In this example, based on weight values (e.g., or other suitable measures of influence or contribution) the model service 109 determines that the location's low cost of living and proximity to talent pools, were the most positively impacting parameters, and the model service 109 determines that the location's lack of high speed internet was the most negatively impacting parameter. In one or more embodiments, determining the one or more most influential parameters includes determining one or more parameters that demonstrated the greatest or lowest direct and/or indirect cost. In one example, for a location classified as “less likely to be suitable,” the model service 109 determines that an associated salary trend imposed the greatest direct cost and that a lack of high speed internet imposed the greatest indirect cost.

At step 224, the process 200 includes performing one or more appropriate actions. In at least one embodiment, the computing environment 101 transmits output of one or more machine learning models to one or more computing devices 105. For example, the computing environment 101 transmits a ranking of locations to the location application 129 and the location application 129 renders the ranking on the display 125. In at least one embodiment, the computing environment 101 transmits an output in the form of an alert, text message, electronic mail, push notification, instant message, document (e.g., a word document, PDF, etc.), spreadsheet (for example, a CSV file or Excel file), or presentation file (for example, a PowerPoint file). In another example, the computing environment 101 transmits a location score and one or more additional scores (e.g., collaboration score, remote score, etc.) of a top-ranked location to the computing device 105. In another example, the computing environment 101 generates and hosts a report at a particular networking address that is accessible via the location application 129 and/or a browser of the computing device 105. In another example, the computing environment 101 generates and reports a list of candidates for the particular position based on one or more top-ranked locations.

In various embodiments, the location application 129 causes the computing device 105 to render an interface that includes the top-ranked locations and most influential parameters for each location (for example, in the form of a table or other suitable graphic). In at least one embodiment, the computing environment 101 generates a searchable report that details each parameter for each candidate location (e.g., or a subset of top-ranked locations), the metric score for each parameter, the ranking of each parameter at each candidate location relative to the like-factors at the other candidate locations, and/or a total estimated cost of filling the particular position at each candidate location. In some embodiments, the location application 129 causes a geolocation application on the computing device 105 to render a searchable map including one or more candidate locations and corresponding location score, classification, and/or additional factors.

In various embodiments, the model service 109 computes a cost differential by comparing a candidate location's overall cost to an overall cost demonstrated by a lowest ranked (e.g., or otherwise most affordable, or user-preferred) candidate location. In one example, the computing environment 101 generates a searchable report indicating that an overall cost of $100,000 to fill the position at Office Location A, an overall cost of $125,000 to fill the position at Office Location B, and an overall cost at $90,000 to fill the position at Office Location C. In the same example, as part of the searchable report, the computing environment 101 reports a first cost differential of $10,000 to locate the position at Office Location A and a second cost differential of $35,000 at Office Location B. In another example, the computing environment 101 determines that a user prefers to fill a position in Atlanta. In the same example, the computing environment 101 evaluates and ranks rank ten office locations, wherein an Atlanta office location ranks fourth on the overall location score ranking. Continuing the example, the computing environment 101 generates a searchable report that, in part, compares the costs associated with hiring a person for the job posting in each of the office locations relative to the costs associated with hiring a person in Atlanta. In some embodiments, the computing environment 101 reports a cost differential based on a comparison between an overall cost to fill the position at each location and an overall cost to fill the position remotely (e.g., the computing environment 101 may evaluate “fully remote” as an additional candidate location).

FIG. 3 shows an exemplary machine learning process 300 (FIG. 3), according to one embodiment of the present disclosure.

At step 303, the process 300 includes generating one or more machine learning models for estimating a suitability of a location for filling a particular position. In various embodiments, step 303 includes including configuring the parameters of the one or more machine learning models and, in some embodiments, adjusting weight values applied to the one or more parameters (e.g., or adjusting other model settings and properties). In one or more embodiments, step 303 includes adjusting the weight values or other transformations to reduce an error metric of the trained machine learning model and, thereby, create a secondary iteration of the machine learning model that demonstrates more accurate and/or precise performance.

In at least one embodiment, generating the machine learning model includes creating a plurality of parameters based on various factors that may influence a location's suitability for filling a position. In some embodiments, the model service 109 generates the plurality of parameters based on entity data and metadata derived therefrom (e.g., referring to entity data and metadata obtained via steps 203-209 of the process 200). In various embodiments, the model service 109 generates a machine learning model based on historical model data 123. For example, the model service 109 retrieves historical model data 123 that defines a trained machine learning model, and the model service 109 retrains the machine learning model using one or more training datasets (e.g., that may utilize more current data and/or may be specific to a particular location or set of locations). Non-limiting examples of machine learning models include neural networks, gradient boosting algorithms, mutual information classifiers, random forest classification, and other machine learning and related algorithms. In at least one embodiment, the model service 109 combines one or more machine learning models to generate an ensemble machine learning model.

At step 306, the process 300 includes training the machine learning model to accurately and precisely generate output, such as, for example, location scores, location classifications, collaboration scores, remote work scores, supply-demand ratios, and distributions of talent. In at least one embodiment, training the machine learning model includes executing the machine learning model on training data to generate experimental outcomes. In at least one embodiment, training the machine learning model includes generating parameters and coefficients in the machine learning model using training data that includes known outcomes such that the parameters and coefficients cause the machine learning model to be predictive for the training data of the known outcomes (e.g., based on determining correlations in inputs from the training data predictive of the known outcomes). In various embodiments, training data includes one or more training datasets generated at step 212 of the process 200 (FIG. 2) and/or training data retrieved from the data store 113 (e.g., from model data 123) or from a data source 103. In one or more embodiments, the training dataset includes data defining a particular position (for example, one or more job descriptions), a plurality of known locations, entity data associated with each of the plurality of known locations, metadata derived from the entity data, and known outcomes (e.g., known location scores, location classifications, or other metrics to which experimental outcomes may be compared).

At step 309, the process 300 includes determining whether the machine learning model satisfies one or more accuracy, precision, and/or error thresholds based on the experimental output generated at step 306. The threshold can be predetermined (for example, the threshold can be retrieved from model data 123) or dynamically computed based on a use case of the machine learning model being trained. In one example, the threshold is defined based on a user input (e.g., a user may select a requisite level of accuracy for the model). In another example, the threshold can be computed based on historical position fulfillment information and historical entity data associated with one or more locations of the entity with which a user is associated.

In at least one embodiment, determining whether the machine learning model satisfies a threshold includes comparing experimental outcomes generated at step 306 to known outcomes of the corresponding training dataset. In one example, the model service 109 computes an error metric based on a level of similarity between the experimental outcomes and the known outcomes. In at least one embodiment, the model service compares the model error (e.g., or model accuracy, precision, etc.) to the predetermined threshold and adjusts model training based on the comparison. According to one embodiment, in response to determining the machine learning model fails to satisfy one or more thresholds, the process 300 proceeds to step 312. In various embodiments, in response to determining the machine learning model satisfies one or more thresholds, the process 300 proceeds to step 315.

At 312, the process 300 includes determining one or more sources of error, inaccuracy, or imprecision that contributed to or caused the machine learning model to violate the one or thresholds. In at least one embodiment, the model service 109 determines one or more parameters, parameter weight values, or other model settings and properties that contributed to the model error or that, if adjusted, may improve performance of the model. In various embodiments, following step 312, the process 300 returns to step 303 and the model service 109 adjusts one or more parameters, parameter weight values, or other model settings and properties to reduce the model error. In one example, at step 312, the model service 109 determines that a weight value for a “time to fill role” parameter is too high and, thereby, caused the machine learning model to generate inaccurate location scores or classifications (e.g., based on comparisons to known outcomes to which the experimental output were compared). In this example, the process 300 proceeds to step 303 and the model service 109 generates a second iteration of the machine learning model in which the weight value for the “time to fill role” parameter is reduced. Continuing the example, the process 300 proceeds to steps 306 and the second iteration of the machine learning model generates additional experimental output for evaluation at step 309.

The system can iteratively repeat steps 303-312, thereby continuously training and/or combining the one or more machine learning models until a particular machine learning model demonstrates one or more error metrics below a predefined threshold, or demonstrates an accuracy and/or precision at or above one or more predefined thresholds.

At 315, the process 300 includes performing one or more appropriate actions. In at least one embodiment, an appropriate action includes generating location scores and/or classifications for a plurality of locations by executing the trained machine learning model on data and metadata obtained at steps 203-209 of the process 200. In one example, upon determining that an iteration of the machine learning model satisfies an error, accuracy, and/or precision threshold, the model service 109 executes the trained machine learning model on entity data of steps 203-206 and metadata derived therefrom at step 209. In this example, the trained machine learning model can generate a location score for each of a plurality of candidate locations defined in the entity data, and the model service 109 can classify the hiring suitability of each of the plurality of candidate locations according to their location score. In one or more embodiments, an appropriate action includes storing the threshold-satisfying iteration of the machine learning model as model data 123. In various embodiments, an appropriate action includes retraining the machine learning model using additional training datasets (e.g., to avoid overfitting the machine learning model to the first training dataset). In at least one embodiment, an appropriate action includes performing additional iterations of the process 300 to generate and train machine learning models for predicting other metrics, such as, for example, collaboration scores, remote work scores, supply-demand ratios, and talent distributions. According to one embodiment, because the additional metrics may be used as inputs to the location suitability machine learning model, the model service 109 generates and trains machine learning models for estimating the additional metrics prior to training the location suitability model.

From the foregoing, it will be understood that various aspects of the processes described herein are software processes that execute on computer systems that form parts of the system. Accordingly, it will be understood that various embodiments of the system described herein are implemented as specially-configured computers including various computer hardware components and, in many cases, significant additional features as compared to conventional or known computers, processes, or the like, as discussed in greater detail herein. Embodiments within the scope of the present disclosure also include computer-readable media for carrying or having computer-executable instructions or data structures stored thereon. Such computer-readable media can be any available media which can be accessed by a computer, or downloadable through communication networks. By way of example, and not limitation, such computer-readable media can include various forms of data storage devices or media such as RAM, ROM, flash memory, EEPROM, CD-ROM, DVD, or other optical disk storage, magnetic disk storage, solid state drives (SSDs) or other data storage devices, any type of removable non-volatile memories such as secure digital (SD), flash memory, memory stick, etc., or any other medium which can be used to carry or store computer program code in the form of computer-executable instructions or data structures and which can be accessed by a computer, special purpose computer, specially-configured computer, mobile device, etc.

When information is transferred or provided over a network or another communications connection (either hardwired, wireless, or a combination of hardwired or wireless) to a computer, the computer properly views the connection as a computer-readable medium. Thus, any such connection is properly termed and considered a computer-readable medium. Combinations of the above should also be included within the scope of computer-readable media. Computer-executable instructions include, for example, instructions and data which cause a computer, special purpose computer, or special purpose processing device such as a mobile device processor to perform one specific function or a group of functions.

Those skilled in the art will understand the features and aspects of a suitable computing environment in which aspects of the disclosure may be implemented. Although not required, some of the embodiments of the claimed systems may be described in the context of computer-executable instructions, such as program modules or engines, as described earlier, being executed by computers in networked environments. Such program modules are often reflected and illustrated by flow charts, sequence diagrams, exemplary screen displays, and other techniques used by those skilled in the art to communicate how to make and use such computer program modules. In some embodiments, program modules include routines, programs, functions, objects, components, data structures, application programming interface (API) calls to other computers whether local or remote, etc. that perform particular tasks or implement particular defined data types, within the computer. Computer-executable instructions, associated data structures and/or schemas, and program modules represent examples of the program code for executing steps of the methods disclosed herein. The particular sequence of such executable instructions or associated data structures represent examples of corresponding acts for implementing the functions described in such steps.

Those skilled in the art will also appreciate that the claimed and/or described systems and methods may be practiced in network computing environments with many types of computer system configurations, including personal computers, smartphones, tablets, hand-held devices, multi-processor systems, microprocessor-based or programmable consumer electronics, networked PCs, minicomputers, mainframe computers, and the like. Embodiments of the claimed system are practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

An exemplary system for implementing various aspects of the described operations, which is not illustrated, includes a computing device including a processing unit, a system memory, and a system bus that couples various system components including the system memory to the processing unit. The computer will typically include one or more data storage devices for reading data from and writing data to. The data storage devices provide nonvolatile storage of computer-executable instructions, data structures, program modules, and other data for the computer.

Computer program code that implements the functionality described herein typically includes one or more program modules that may be stored on a data storage device. This program code, as is known to those skilled in the art, usually includes an operating system, one or more application programs, other program modules, and program data. A user may enter commands and information into the computer through keyboard, touch screen, pointing device, a script containing computer program code written in a scripting language or other input devices (not shown), such as a microphone, etc. These and other input devices are often connected to the processing unit through known electrical, optical, or wireless connections.

The computer that effects many aspects of the described processes will typically operate in a networked environment using logical connections to one or more remote computers or data sources, which are described further below. Remote computers may be another personal computer, a server, a router, a network PC, a peer device or other common network node, and typically include many or all of the elements described above relative to the main computer system in which the systems are embodied. The logical connections between computers include a local area network (LAN), a wide area network (WAN), virtual networks (WAN or LAN), and wireless LANs (WLAN) that are presented here by way of example and not limitation. Such networking environments are commonplace in office-wide or enterprise-wide computer networks, intranets, and the Internet.

When used in a LAN or WLAN networking environment, a computer system implementing aspects of the system is connected to the local network through a network interface or adapter. When used in a WAN or WLAN networking environment, the computer may include a modem, a wireless link, or other mechanisms for establishing communications over the wide area network, such as the Internet. In a networked environment, program modules depicted relative to the computer, or portions thereof, may be stored in a remote data storage device. It will be appreciated that the network connections described or shown are exemplary and other mechanisms of establishing communications over wide area networks or the Internet may be used.

While various aspects have been described in the context of a preferred embodiment, additional aspects, features, and methodologies of the claimed systems will be readily discernible from the description herein, by those of ordinary skill in the art. Many embodiments and adaptations of the disclosure and claimed systems other than those herein described, as well as many variations, modifications, and equivalent arrangements and methodologies, will be apparent from or reasonably suggested by the disclosure and the foregoing description thereof, without departing from the substance or scope of the claims. Furthermore, any sequence(s) and/or temporal order of steps of various processes described and claimed herein are those considered to be the best mode contemplated for carrying out the claimed systems. It should also be understood that, although steps of various processes may be shown and described as being in a preferred sequence or temporal order, the steps of any such processes are not limited to being carried out in any particular sequence or order, absent a specific indication of such to achieve a particular intended result. In most cases, the steps of such processes may be carried out in a variety of different sequences and orders, while still falling within the scope of the claimed systems. In addition, some steps may be carried out simultaneously, contemporaneously, or in synchronization with other steps.

Aspects, features, and benefits of the claimed devices and methods for using the same will become apparent from the information disclosed in the exhibits and the other applications as incorporated by reference. Variations and modifications to the disclosed systems and methods may be effected without departing from the spirit and scope of the novel concepts of the disclosure.

It will, nevertheless, be understood that no limitation of the scope of the disclosure is intended by the information disclosed in the exhibits or the applications incorporated by reference; any alterations and further modifications of the described or illustrated embodiments, and any further applications of the principles of the disclosure as illustrated therein are contemplated as would normally occur to one skilled in the art to which the disclosure relates.

The foregoing description of the exemplary embodiments has been presented only for the purposes of illustration and description and is not intended to be exhaustive or to limit the devices and methods for using the same to the precise forms disclosed. Many modifications and variations are possible in light of the above teaching.

The embodiments were chosen and described in order to explain the principles of the devices and methods for using the same and their practical application so as to enable others skilled in the art to utilize the devices and methods for using the same and various embodiments and with various modifications as are suited to the particular use contemplated. Alternative embodiments will become apparent to those skilled in the art to which the present devices and methods for using the same pertain without departing from their spirit and scope. Accordingly, the scope of the present devices and methods for using the same is defined by the appended claims rather than the foregoing description and the exemplary embodiments described therein.

What is claimed is:

1. A machine learning system, comprising:
a data store comprising entity data corresponding to an entity;
at least one computing device in communication with the data store, the at least one computing device being configured to:
receive data describing at least one aspect of a position for the entity;
generate metadata for the position based on the data describing the at least one aspect of the position, the metadata comprising a plurality of skills and tasks associated with the position;
identify a plurality of task locations for the entity;
determine a distribution of capacity across the plurality of task locations based on the entity data;
generate a plurality of metric scores comprising a collaboration score, a remote work score, and an estimated remuneration range across each of the plurality of task locations; and
generate a plurality of location scores for each of the plurality of task locations based on a weighing of each of the plurality of metric scores.

2. The machine learning system of claim 1, wherein the at least one computing device is further configured to generate a user interface including a subset of the plurality of task locations according to a ranking of the plurality of location scores.

3. The machine learning system of claim 1, wherein the at least one computing device is further configured to generate the plurality of location scores using deep learning and natural language processing on the plurality of metric scores.

4. The machine learning system of claim 1, wherein the plurality of metric scores comprises a projected remuneration trend across each of the plurality of task locations.

5. The machine learning system of claim 1, wherein the plurality of metric scores comprises a supply to demand ratio at each of the plurality of task locations.

6. The machine learning system of claim 1, wherein the at least one computing device is further configured generate the plurality of location scores by applying a machine learning model.

7. The machine learning system of claim 6, wherein the at least one computing device is further configured train the machine learning model using a training data set comprising a plurality of inputs and a plurality of known outcomes corresponding to the inputs.

8. A machine learning method, comprising:
receiving, via at least one computing device, data describing at least one aspect of a position for an entity;
generating, via the at least one computing device, metadata for the position based on the data describing the at least one aspect of the position, the metadata comprising a plurality of skills and tasks associated with the position;
identifying, via the at least one computing device, a plurality of task locations for the entity;
determining, via the at least one computing device, a distribution of capacity across the plurality of task locations based on entity data for the entity;
generating, via the at least one computing device, a plurality of metric scores comprising a collaboration score, a remote work score, an estimated remuneration range across each of the plurality of task locations; and
generating, via the at least one computing device, a plurality of location scores for each of the plurality of task locations based on a weighing of each of the plurality of metric scores.

9. The machine learning method of claim 8, further comprising:
periodically retrieving task data from a plurality of third party data sources; and
processing the retrieved task data to generate processed task data, wherein the metadata is further based on the processed task data.

10. The machine learning method of claim 8, further comprising:
determining at least one most influential parameter associated with the plurality of location scores; and
rendering a user interface comprising the at least one most influential parameter on a display.

11. The machine learning method of claim 8, further comprising performing entity resolution on the plurality of task locations prior to determining the distribution of capacity across the plurality of task locations.

12. The machine learning method of claim 8, wherein the entity data comprising data describing a plurality of individuals associated with the entity, and the method further comprises anonymizing the entity data to remove identifying information corresponding to the plurality of individuals associated with the entity.

13. The machine learning method of claim 8, further comprising:
determining differential data between at least two task locations of the plurality of task locations, wherein the differential data comprises a differential of a first parameter associated with one of the plurality of metric scores for each of the at least two task locations; and
rendering a user interface comprising the differential data.

14. A non-transitory computer-readable medium embodying a program that, when executed by at least one computing device, causes the at least one computing device to:
receive data describing at least one aspect of a position for an entity;
generate metadata for the position based on the data describing the at least one aspect of the position, the metadata comprising a plurality of skills and tasks associated with the position;
identify a plurality of task locations for the entity;
determine a distribution of capacity across the plurality of task locations based on entity data for the entity;
generate a plurality of metric scores comprising a collaboration score, a remote work score, an estimated remuneration range across each of the plurality of task locations; and
generate a plurality of location scores for each of the plurality of task locations based on a weighing of each of the plurality of metric scores.

15. The non-transitory computer-readable medium of claim 14, wherein the program further causes the at least one computing device to generate at least one of the plurality of metric scores according to a step function.

16. The non-transitory computer-readable medium of claim 15, wherein the program further causes the at least one computing device to determine one or more coefficients associated with the step function based on the metadata.

17. The non-transitory computer-readable medium of claim 15, wherein the program further causes the at least one computing device to determine one or more interval associated with the step function based on the metadata.

18. The non-transitory computer-readable medium of claim 14, wherein the program further causes the at least one computing device to exclude a particular task location of the plurality of task locations based on a particular one of the plurality of metric scores falling below a predefined threshold.

19. The non-transitory computer-readable medium of claim 14, wherein the program further causes the at least one computing device to generate an overall location score by combining the plurality of location scores according to a predetermined weighting.

20. The non-transitory computer-readable medium of claim 19, wherein the program further causes the at least one computing device to compute the predetermined weighting for combining the plurality of location scores based on the metadata.
